(19) United States
(12) Patent Application Publication
(10) Pub. No.: US 2026/0319213 A1
(43) Pub. Date: Oct. 15, 2026

(54) ASSEMBLIES TO CONNECT AND ALIGN A LENS ASSEMBLY

(71) Applicant: GoPro, Inc., San Mateo, CA (US)

(72) Inventor: Ian Copeland Griggs, San Francisco, CA (US)

(21) Appl. No.: 19/174,307

(22) Filed: Apr. 9, 2025

(51) Int. Cl. G02B 7/00; G02B 7/02

(52) U.S. Cl. CPC G02B 7/003; G02B 7/021; G02B 7/025

(57) ABSTRACT

A lens assembly includes a lens barrel defining an optical axis. The lens barrel includes a lens mounting surface orthogonal to the optical axis and a lateral alignment wall parallel with the optical axis. The lens assembly includes a lens mount that surrounds at least a portion of and is connected with the lens barrel and a connection flange extended from either the lens barrel and/or the lens mount. The lens assembly includes a bayonet that includes a base and a locking mechanism having a lateral internal wall extended parallel from the base relative to the optical axis and a support wall that is extended orthogonal from the lateral internal wall relative to the optical axis; and a support flange extended from the base and toward the connection flange such that the support flange and the connection flange are aligned.

### TECHNICAL FIELD

This disclosure relates to an imaging sensor and lens assembly (ISLA) with one or more lenses where some of the lenses are movable relative to one another to adjust an air gap between the lenses.

### BACKGROUND

Image capture devices utilize precise lens alignment to achieve high resolution images. In modern image capture devices, a lens or series of lenses are connected to a body of a lens barrel and moved into focal alignment with an imaging sensor that is located within the housing of the image capture devices. Due to a variety of factors, such as manufacturing steps, material tolerances, and/or material changes during assembly, the lens or series of lenses may be several microns or millimeters misaligned from focal alignment with the imaging sensor. This misalignment can negatively impact light detection and subsequent image capturing. Accordingly, what is needed are techniques to correct misalignment before image capture such that ideal focal alignment is achieved between the lens or series of lenses and the imaging sensor. Additionally, what is needed are techniques to modify lens alignment relative to an imaging sensor.

### SUMMARY

Disclosed herein are implementations of a lens assembly including a lens barrel defining an optical axis. The lens barrel includes a lens mounting surface orthogonal to the optical axis and a lateral alignment wall parallel with the optical axis. The lens assembly includes a lens mount that surrounds at least a portion of and is connected with the lens barrel and a connection flange extended from either the lens barrel and/or the lens mount. The lens assembly includes a bayonet that includes a base and a locking mechanism having a lateral internal wall extended parallel from the base relative to the optical axis and a support wall that is extended orthogonal from the lateral internal wall relative to the optical axis; and a support flange extended from the base and toward the connection flange such that the support flange and the connection flange are aligned. The lens assembly includes an adhesive that connects the support flange and the connection flange.

In some examples, the connection flange and the support flange may be collaterally aligned. The lens barrel and the bayonet may be aligned along the optical axis. The adhesive may contact surfaces of the support flange and the connection flange that are either orthogonal or parallel to the optical axis. The adhesive may contact surfaces of both the support flange and the connection flange that are orthogonal and parallel with the optical axis. The lens assembly further includes a fixture configured to axially align the bayonet and the lens barrel with the optical axis before curing of the adhesive. The fixture may include a first support configured to contact the lens mounting surface and the lateral alignment wall of the lens barrel and a second support configured to contact the lateral internal wall of the bayonet. The fixture includes a channel defined between the first support and the second support and a peripheral wall extended around the second support and configured to contact the support wall.

Disclosed herein are implementations of a lens assembly that includes a cover assembly that includes a cover housing that defines. The cover housing includes a cover channel configured to interface with a housing bayonet and a lens cavity disposed between a peripheral wall and a lens shelf. The cover assembly includes a cover lens positioned within the lens cavity and free of contact with the lens shelf at an internal surface of the cover lens. The lens assembly includes a bayonet plate connected with the lens assembly and configured to interface with the housing bayonet and an adhesive that connects the lens shelf and the cover lens.

In some examples, the cover lens may include an external surface that is planar and parallel relative to the lens shelf, and the lens shelf and the external surface may be orthogonal relative to an optical axis. The cover lens may include the internal surface and the external surface are planar and parallel relative to inner surface. The cover lens may be aligned along the optical axis. The cover lens may be free of contact with the peripheral wall. The lens assembly may further include a fixture that includes a first support that aligns the cover lens and the lens shelf at the optical axis and a second support extended from a channel between the first support and the second support and the second support may connect with the bayonet plate at the cover channel. The first support may extend through the lens cavity and above a plane of the lens shelf, and the second support may be configured as a bayonet connection.

Disclosed herein are implementations that include an image capture apparatus include a lens. The lens includes an outer surface that is planar or convex, an inner surface that is concave, and a peripheral surface that connects the inner surface and the outer surface. The image capture apparatus includes a housing that defines a cavity configured to align with the peripheral surface and has a support flange extended from the cavity at an angle sufficient to align with a portion of the inner surface of the lens and an adhesive that connects the support flange and the inner surface.

The support flange and the inner surface may have an angle that is substantially similar relative to the peripheral surface. The outer surface may be convex. The peripheral surface and sides of the cavity may be parallel relative to each other. The outer surface may be planar and substantially perpendicular relative to an optical axis that extends from an imaging sensor. The support flange and the inner surface may have an angle that is different relative to the peripheral surface.

Disclosed herein are implementations that include an image capture apparatus that includes a lens assembly connected with an image capture apparatus housing. The lens assembly includes a lens mount, one or more lenses integrated within the lens mount, and an outer housing that encloses lateral sides of the lens mount. The image capture device includes a cover lens connectable with the lens assembly at a connection mechanism that is located between the outer housing and the lens mount so that sides of the cover lens are enclosed by the outer housing.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIGS. 6A-6B are perspective views of a lens assembly.

FIG. 6C is a cross-sectional view of the lens assembly along lines VIC-VIC.

FIGS. 7A-7B are perspective views of a lens assembly.

FIG. 7C is a cross-sectional view of the lens assembly along lines VIIC-VIIC.

FIG. 8 is a cross-sectional view of a lens assembly.

FIG. 9 is a perspective view of an image capture apparatus.

### DETAILED DESCRIPTION

The present disclosure describes techniques to connect external lenses, bayonets, lens barrels, and image capture device housings such that the imaging sensor and an internal lens are desirably aligned along one or more axes. To achieve desirable image results, the internal lens should be aligned with an imaging sensor along one or more axes.

In one implementation, the disclosure describes techniques and apparatuses to align a lens barrel and a bayonet using adhesives and a fixture such that the bayonet will be configured to align with external bayonet plates of an external cover assembly that includes a lens. The fixture functions to provide a template to align the lens barrel and the bayonet relative to each other, and consequently the internal lens, so that subsequent connection with the bayonet plate and external lens does not cause a misalignment between the internal and external lens. The adhesive is initially uncured and allows for the lens barrel to be shifted along multiple axes relative to the bayonet and aligned with the fixture. Once the bayonet and the lens barrel are aligned, the adhesive is cured. By adjusting and mitigating the misalignment at the lens barrel and the bayonet, misalignment along one or more axes is mitigated between the imaging sensor and external lens (e.g., the cover assembly discussed herein) including the lens.

In another implementation, the disclosure provides for using a fixture to align an external lens with a bayonet plate in a cover assembly that is configured to connect with a bayonet of a lens barrel, which optionally includes an imaging sensor. The external lens is positioned with the fixture to a desirable alignment along one or more of the axes and then connected with the cover assembly via an adhesive that is uncured. Once the external lens is adjusted to align desirably along one or more axes using the fixture with the bayonet plate, the adhesive is cured such that the lens remains aligned with the bayonet plate when the bayonet plate is connected with the bayonet associated with the lens barrel. By aligning the bayonet plate with the lens before connecting with the bayonet, misalignment of the lens with an imaging sensor and/or internal lens of the lens barrel is eliminated or mitigated.

In another implementation, the disclosure provides for using a lens that has a concave internal surface to achieve improved optics instead of a flat internal surface. The internal surface is connected with a receptacle or other portion of an image capture device, and therefore, part of the lens may be obstructed by edges, ledges, or flanges of the image capture device. The curved internal surface provides for additional surface area to align with the external surface and allow the passage of light to the imaging sensor. Since the curved internal surface provides for additional surface area to allow for the passage of light through the lens, the lens can be shrunk, relative to a flat internal surface, and achieve the same optics, or the lens can be left the same size and achieve better optics. Additionally, the inclusion of a curved internal surface allows for more surfaces to connect or adhere to the lens to the housing, without impacting the optics of the lens.

In another implementation, the present disclosure provides for lens assembly including an external lens that is protected from impact when the image capture device is dropped. The lens assembly is configured to releasably connect with the image capture device, optionally overlaying another internal lens, at a receptacle and between external and internal lateral walls of the image capture device. Because the lens assembly is between the external and internal lateral walls, when the image capture device is dropped or bumped, the impact is at least in part absorbed by the external wall and, thus, protects or extends the life of the lens assembly. Since the lens assembly is releasably connectable with the image capture device, the lens assembly can be easily exchanged to correct scratching on the external lens or to change the shade of the lens of the external lens.

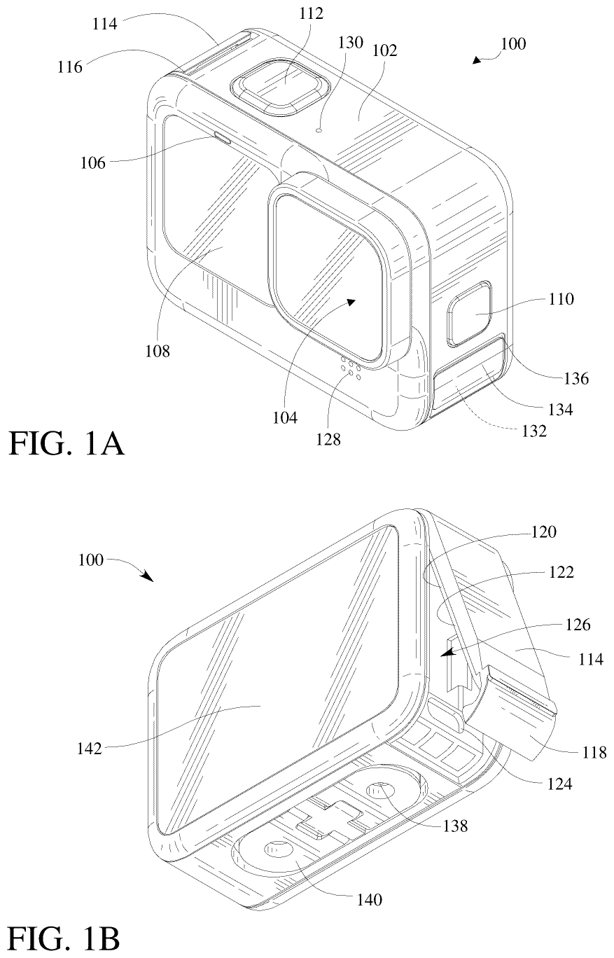

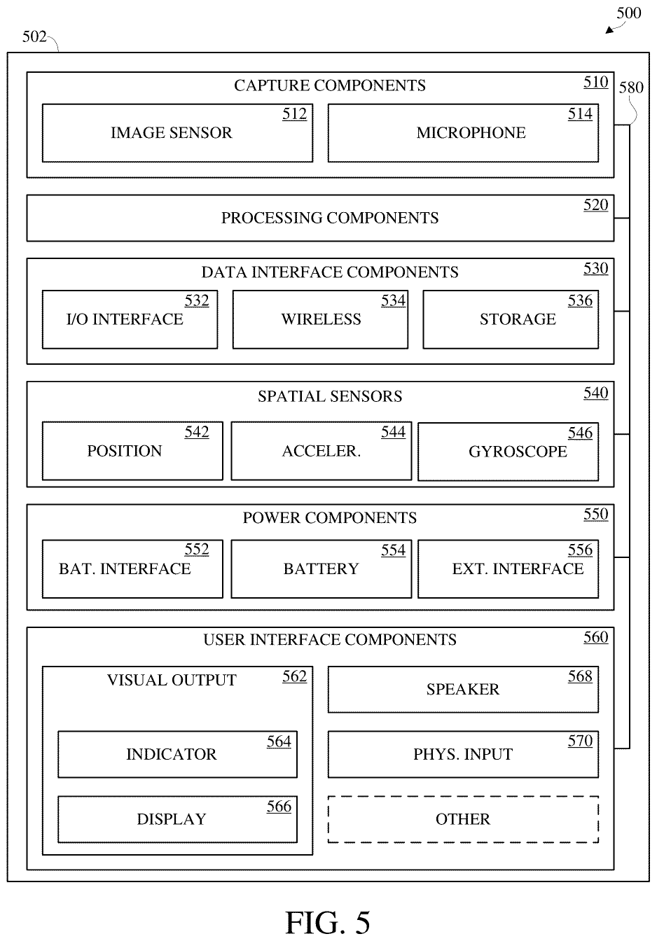

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an imaging sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

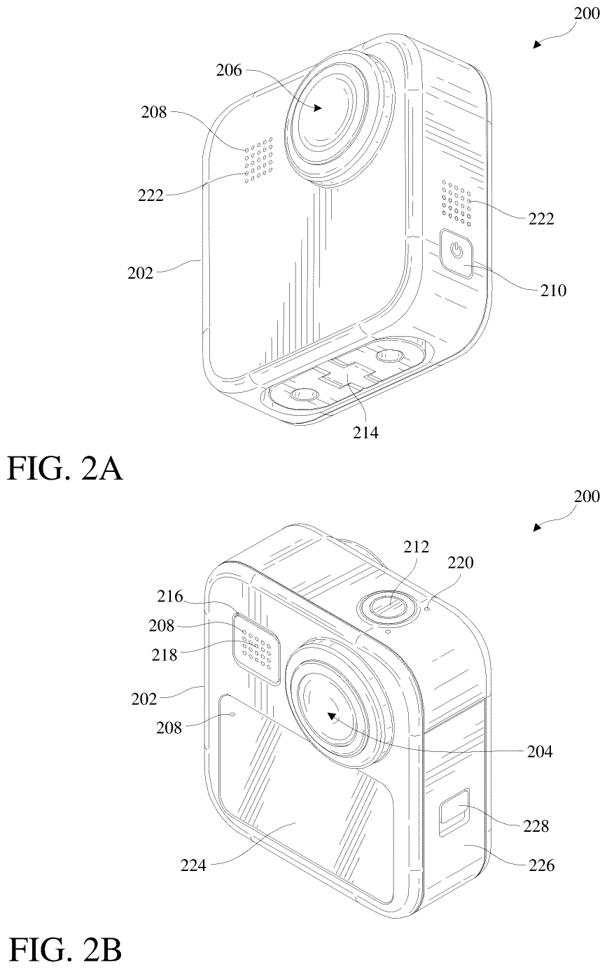

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

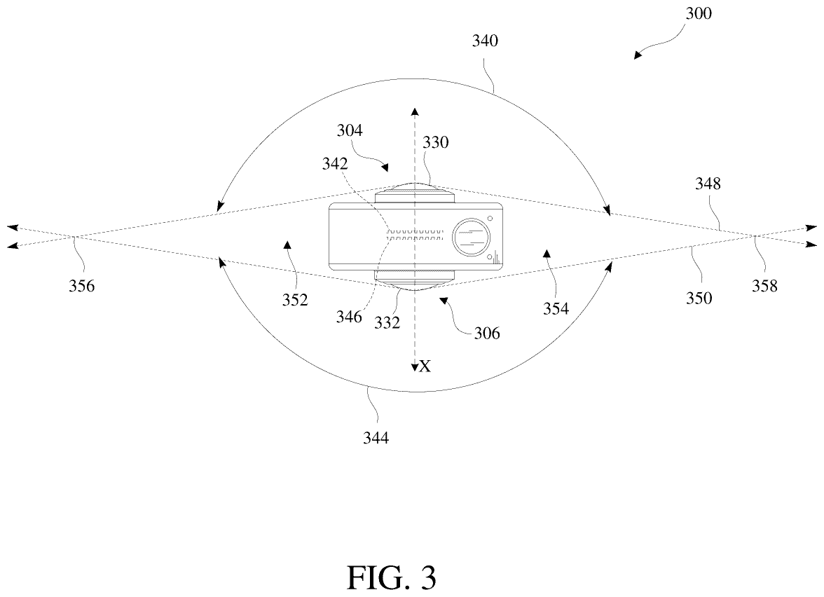

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first imaging sensor 342 of the first image capture device 304. For example, the first image capture device 304 may include a first lens barrel (not expressly shown), extending from the first lens 330 to the first imaging sensor 342.

The second image capture device 306 defines a second field-of-view 344 wherein the second lens 332 receives light. The second lens 332 directs the received light corresponding to the second field-of-view 344 onto a second imaging sensor 346 of the second image capture device 306. For example, the second image capture device 306 may include a second lens barrel (not expressly shown), extending from the second lens 332 to the second imaging sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first imaging sensor 342 captures a first hyper-hemispherical image plane from light entering the first lens 330. The second imaging sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding imaging sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective imaging sensors 342, 346 may be combined to form a combined image, such as a spherical image. Generating a combined image may include correlating the overlapping regions captured by the respective imaging sensors 342, 346, aligning the captured fields-of-view 340, 344, and stitching the images together to form a cohesive combined image. Stitching the images together may include correlating the overlap points 356, 358 with respective locations in corresponding images captured by the imaging sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the imaging sensors 342, 346, or both, may change the relative positions of the respective fields-of-view 340, 344, may change the locations of the overlap points 356, 358, such as with respect to images captured by the imaging sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the imaging sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

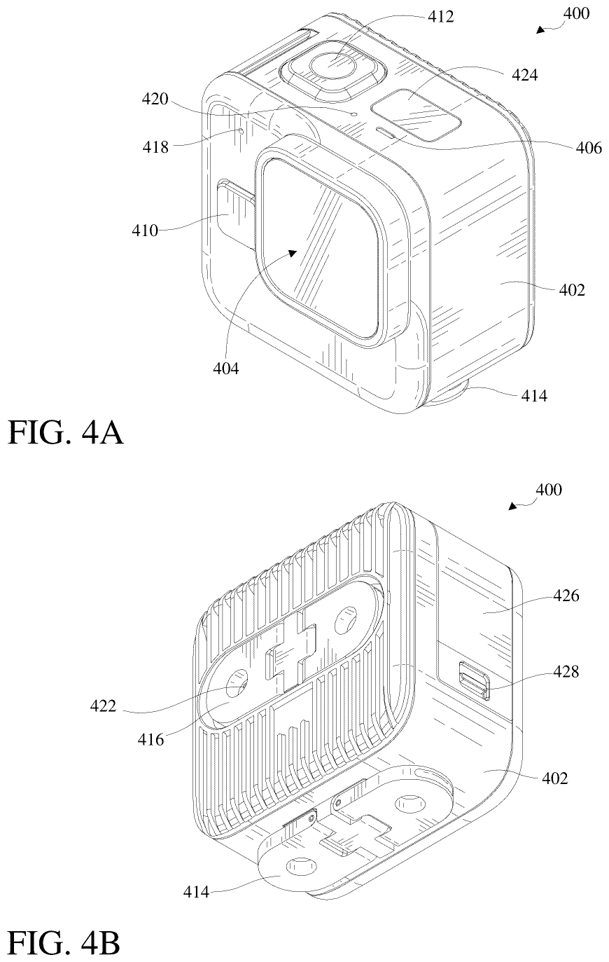

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIG. 4A, the image capture apparatus 400 may include other indictors structured on respective surfaces of the body 402.

As shown in FIG. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an imaging sensor 512 for capturing images. Although one imaging sensor 512 is shown in FIG. 5, the capture components 510 may include multiple imaging sensors. The imaging sensor 512 may be similar to the imaging sensors 342, 346 shown in FIG. 3. The imaging sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The imaging sensor 512 detects light, such as within a defined spectrum, such as the visible light spectrum or the infrared spectrum, incident through a corresponding lens such as the first lens 330 with respect to the first imaging sensor 342 or the second lens 332 with respect to the second imaging sensor 346 as shown in FIG. 3. The imaging sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the imaging sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the imaging sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the imaging sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

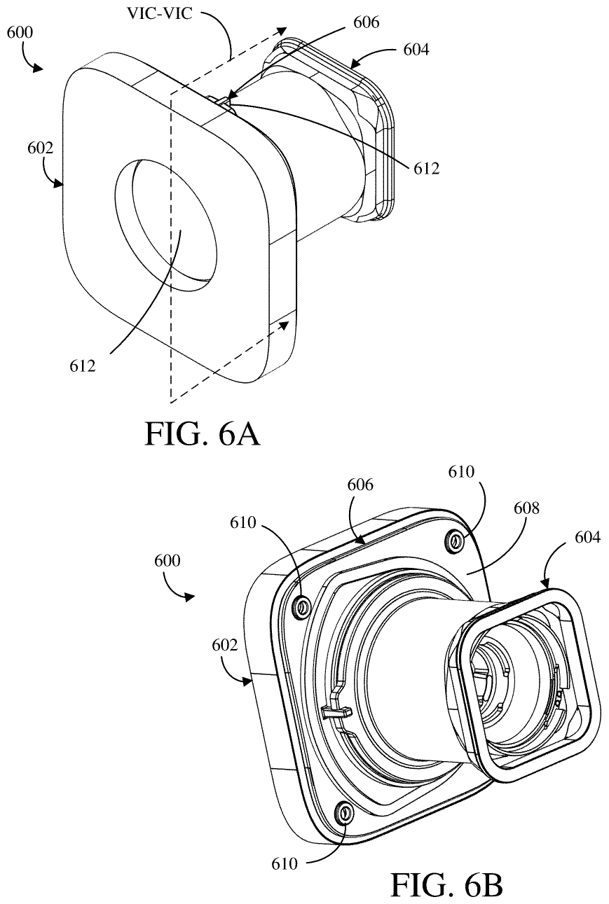

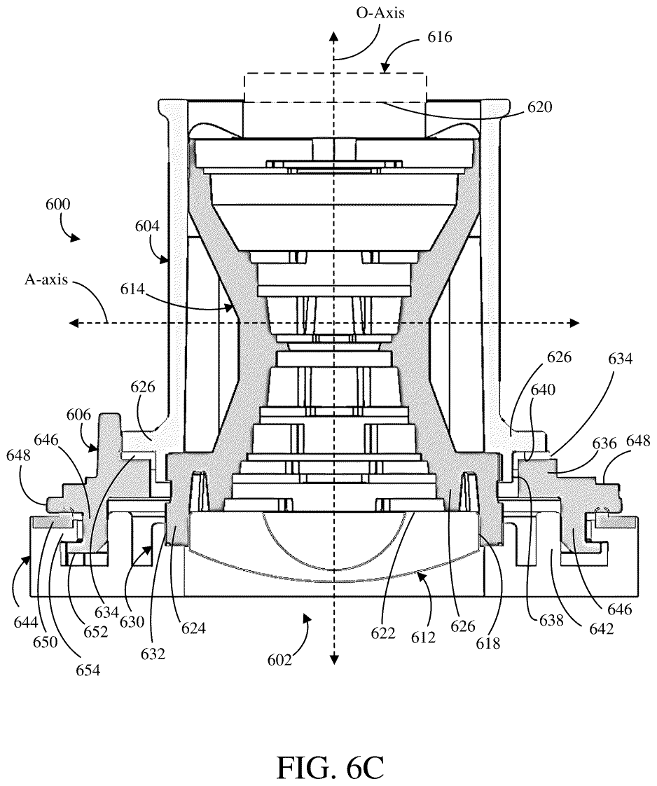

FIG. 6A-6B are perspective views of a lens assembly 600. The lens assembly 600 may be utilized with the image capture devices 100, 200, 300, 400, 500 of FIGS. 1A-5. The lens assembly 600 is connected with a fixture 602 that is configured to align components of the lens assembly 600 during manufacturing or connection steps. The lens assembly 600 includes a lens mount 604 connected with a bayonet 606 that is configured to connect with an external lens (not shown). The bayonet 606 includes a base 608 with apertures 610 defined therein that are configured to connect with fasteners (not shown) during assembly. The fixture 602 connects with the lens mount 604 at a location proximate to or adjacent to a lens 612. The lens 612 may be referred to as an internal lens.

FIG. 6C is a cross-sectional view of the lens assembly 600 along lines VIC-VIC. The lens assembly 600 includes a lens barrel 614 that is connected with the lens mount 604 and an imaging sensor 616 that is configured to align with the lens 612. The imaging sensor 616, the lens mount 604, the lens barrel 614, the bayonet, and/or the lens 612 are aligned along an O-axis (i.e., Optical Axis or Z-axis) and/or an A-axis (i.e., an alignment axis or a combination of an X-axis and Y-axis). In an X-axis, an Y-axis, and an Z-axis relative to the lens assembly 600, the A-axis represents both the X-axis and the Y-axis relative to the O-axis, and the O-axis represents the Z-axis alignment along the O-axis may mean that a peripheral surface 618 of the lens 612 is generally perpendicular or orthogonal to an external surface 620 of the imaging sensor 616. Alignment along the A-axis may mean that an internal surface 622 of the lens 612 is parallel relative to the external surface 620 of the imaging sensor 616.

The lens barrel 614 and the lens mount 604 are connected at a barrel extension 624 of the lens barrel 614 and a mount extension 626 of the lens mount 604 such that the lens barrel 614 and the lens mount 604 are fixedly connected upon assembly with the bayonet 606. The barrel extension 624 extends between the lens mount 604 and the fixture 602 and supports alignment of the lens 612 along the A-axis. Additionally, a barrel support 628 extends from the lens barrel 614 and contacts the internal surface 622 of the lens 612 such that the barrel support 628 assists with alignment of the lens 612 along the O-axis. The combination of the barrel support 628 and the barrel extension 624 support alignment of the lens 612 along both of the A-axis and O-axis such that the lens 612 and the imaging sensor 616 have desirable optical properties.

In other examples, the mount extension 626 may extend from the lens barrel 614 to the bayonet 606, such as when the lens barrel 614 and lens mount 604 are integrated, when the lens mount 604 is not present, or when the lens mount 604 connects with the bayonet 606 through another means. The mount extension 626 may extend from the O-axis at a substantially perpendicular angle or from the A-axis at a substantially parallel angle. Whether extended from the lens mount 604 or the lens barrel 614, the mount extension 626 may be described as a connection flange in which other components or other flanges extend from toward the bayonet 606.

Relative to the fixture 602, the barrel extension 624 contacts the fixture 602 at a first support 630 that includes peripheral and support surfaces configured to contact the barrel extension 624 at a lateral alignment wall 632 of the lens barrel 614. Since the lateral alignment wall 632 is parallel with the O-axis and contacts both the lens 612 and the fixture 602, the lens 612 can be aligned along the A-axis relative to other components (e.g., the bayonet 606 and the lens mount 604) using the fixture 602. Additionally, since the lateral alignment wall 632 contacts the fixture at a support surface, desirable alignment along the O-axis can be achieved relative to the other components.

The mount extension 626 extends between the lens barrel 614 and the bayonet 606 and supports alignment of the bayonet 606 and the lens barrel 614 along the A and O-axis. The connection between the mount extension 626 and the barrel extension 624 may be supported by any fastening means sufficient to combine the two components. For example, the mount extension 626 and the barrel extension 624 may be connected through a threaded fit, snap fit, fusion weld, adhesive, molded fit, or any combination thereof. The mount extension 626 and the barrel extension 624 may be connected before or after alignment with the lens 612. In other examples, the lens barrel 614 and the lens mount 604 are connected at another location, such as proximate to the imaging sensor 616 or at any other location where two surfaces of the lens barrel 614 and the lens mount 604 connect.

In some examples, small deviations in material may cause minor misalignment between components, and to avoid misalignment during formation of the lens assembly 600, an adhesive 634 is positioned between the lens barrel 614 and the bayonet 606 that is uncured and allows for adjustment of the lens barrel 614 and the bayonet 606 relative to each other until the lens 612 is desirably aligned along the O-axis and/or A-axis. For example, an amount of the adhesive 634 sufficient to have desirable thickness (e.g., between about 0.1 microns to 2 mm) along the A and/or O-axis after curing. In other examples, the lens mount 604 may be titled and/or adjusted relative to the bayonet 606 until desirable alignment is achieved, and then, the adhesive 634 is cured such that the desirable alignment between the lens mount 604 and/or the bayonet 606 is retained. In other examples, the adhesive 634 remains uncured until both the bayonet 606 and the lens barrel 614 are contacted and/or connected with the fixture 602, which is generally designed to achieve alignment of the lens 612 without manual adjustment, and then, the adhesive 634 is cured.

The mount extension 626 connects with the bayonet 606 at a first bayonet extension 636 (i.e., a support flange) that extends between lateral and support walls 638, 640 of the mount extension 626 such that the mount extension 626 is supported by at least two surfaces of the first bayonet extension 636. With support from at least two surfaces of the first bayonet extension 636, the lateral and support walls 638, 640 can be utilized to align the bayonet 606 and the lens mount 604 along the aligned with A-axis and/or O-axis. Additionally, the adhesive 634 can be used to modify the alignment of one or more of the A-axis and/or O-axis by changing the amount and/or thickness of the adhesive 634 to change the position of the lens mount 604 and bayonet 606 relative to each other or relative to the fixture 602. For example, the fixture 602 may be arranged and/or configured to support the alignment of all of the components of the lens assembly 600 along the A-axis and O-axis, and the adhesive 634 in an uncured form may be utilized to allow movement between some of the components before curing the adhesive such that alignment is retained or achieved.

The bayonet 606 is supported by the fixture 602 at a second support 642 and a third support 644 that are configured to ensure alignment of the bayonet 606 and components connected with the bayonet 606 (e.g., the lens mount 604 and the lens barrel 614) such that the lens 612 is positioned correctly and to align relative to the imaging sensor 616 and/or the A and/or O-axis. Specifically, the second support 642 contacts a second bayonet extension 646 and supports alignment relative to movement along the A-axis such that the lens 612 and the imaging sensor 616 are properly positioned. Additionally, the third support 644 connects with the second barrel extension 646 and a third barrel extension 648 such that proper alignment is achieved along the O-Axis and, subsequently, achieves alignment of the lens 612. A gasket 650 that is compressible (e.g., an elastomer) is configured to apply a force between the third bayonet extension 648 and the second bayonet extension 646 such that the bayonet 606 is held in a fixed position while the lens assembly 600 is formed (i.e., before, during, or after curing).

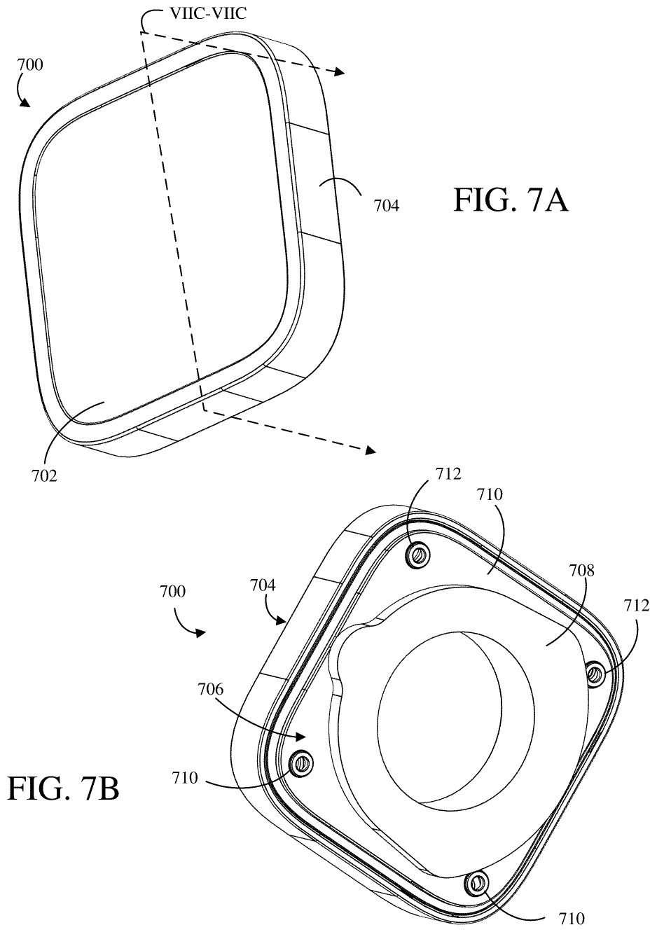

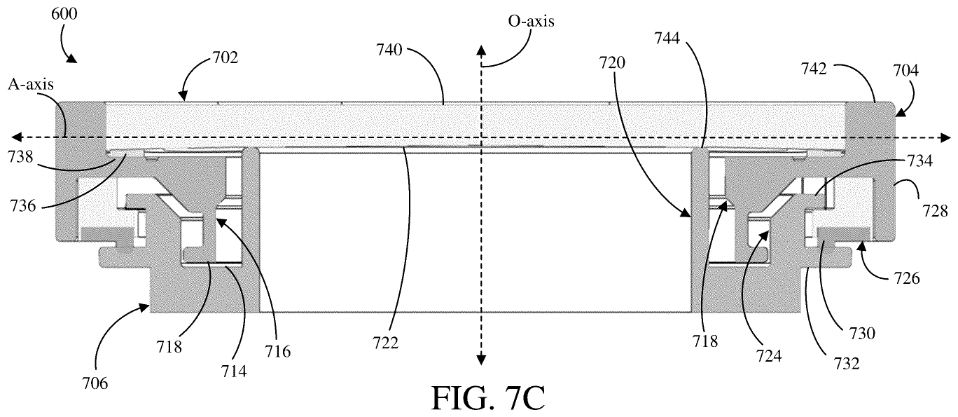

Specifically, a hook 652 of the second bayonet extension 646 connects with a flange 654 of the third support 644 such that a bayonet connection with components of an external lens (e.g., a bayonet plate corresponding to the bayonet 606, see e.g., FIGS. 7A-7C) is imitated or simulated. This arrangement on the fixture 602 allows for a test of alignment for both the bayonet 606 relative to a corresponding connection component and for assuring alignment of the lens 612 along the A and O-axis.

In combination, the first, second, and third bayonet extensions 636, 646, 648 form a base of the bayonet 606 in which the components of the bayonet extend from. In other examples, a different number of bayonet extensions (not shown) may extend from the base to conform with another type of bayonet or locking mechanism. The fixture may be modified such that similar alignment of the lens 612 may be achieved relative to the A and O-axis and the imaging sensor 616.

When the combination of the first, second, and third bayonet extensions 636, 646, 648 is described as a base, the second bayonet extension 646 may extend from the base in a parallel angle relative to the O-axis such that the second bayonet extension forms an inner lateral wall of the bayonet 606 that is configured to connect and with be partially enclosed by a corresponding bayonet plate (not shown). The hook 652 extends from the second bayonet extension 646 at an angle that is orthogonal or perpendicular relative to the O-axis such that the hook 652 is configured as a support wall on an interior surface of the corresponding bayonet plate (not shown). The third bayonet extension 648 extends from the base at a parallel angle relative to the base and at the same direction of extension as the hook 652 such that the third bayonet extension 648 is configured as a support wall on an exterior surface of the corresponding bayonet plate (not shown). The combination of the hook 652 and the third bayonet extension are configured to connect with a flange or support of a corresponding bayonet plate (not shown) on the interior and exterior surfaces. The base is then supported on the mount extension 626 by the first bayonet extension 636 that extends from base at an angle perpendicular or orthogonal to the O-axis and in an opposite direction as the third bayonet extension 648 such that the bayonet is configured to connect with the lens mount 604 and lens barrel 614 and/or align with the lens 612.

Relative to the bayonet 606, the lens barrel 614, and the lens mount 604 and the imaging sensor 616, misalignment along the A and/or O-axis can be detrimental to image quality, even if by a few microns in any direction. Accordingly, the first, second, and third supports 630, 642, 644 of the fixture 602 can be used as a platform to align all of the components with little or no adjustment of the components before curing the adhesive 634. Because the bayonet 606, the lens barrel 614, and the lens mount 604 are positioned together on the fixture before curing, the lens assembly 600 can be checked in one step to determine alignment or to get more consistent alignment between different lens assemblies 600 by using the fixture 602 that is standardized. This mitigates downstream inconsistency in alignment or introduction of error by assembling the bayonet 606, the lens barrel 614, and the lens mount 604 in a sequence before curing of the adhesive 643.

The lens barrel 614 and the bayonet 606 are aligned along the A-axis and O-axis at two different locations (e.g., at the barrel extension 624/barrel support 628 and the second and third bayonet extension 646, 648) such that when assembled the lens barrel 614 and the bayonet 606 are independently aligned along the O-axis and the A-axis and error in alignment or misalignment is reduced relative to the imaging sensor 616 or when the bayonet 606 is connected with an external lens assembly (not shown). This is advantageous to have improved optics in the image capture apparatus or to have the ability to swap external or cover lens assemblies (not shown), while retaining proper alignment relative to the imaging sensor 616.

FIG. 7A-7B are perspective views of a cover assembly 700. The cover assembly 700 may be connectable with the bayonet 606 of the lens assembly 600 of FIGS. 6A-6C. The cover assembly 700 includes a cover lens 702 and a cover housing 704 that are connected with a fixture 706 that is configured to align components of the cover assembly 700 during assembly or manufacture of the cover assembly 700 and before connection with the lens assembly 600. The fixture 706 includes a base 708 connected with a support 710 that defines apertures 712 configured to interface with fasteners (not shown) that are configured to connect the cover assembly 700 and the fixture 706 or a tool (not shown) configured to remove the fixture 706 from the cover assembly 700. Once the fixture 706 aligns the cover lens 702 and the cover housing 704, the fixture 706 may be removed from the cover assembly 700 and the cover assembly 700 may be connected with the bayonet 606 of FIG. 6A with mitigated, minimal, or no misalignment issues relative to the lens 612 and/or the imaging sensor 616.

FIG. 7C is a cross-sectional view of the cover assembly 700 along lines VIIC-VIIC. The base 708 includes a cover channel 714 that is configured to receive a bayonet plate 716 of the cover assembly 700. The cover channel 714 has a non-uniform diameter and/or dimensions (not shown) along the periphery of the support 710 relative to the base 708 such that the bayonet plate 716 is rotatable within the cover channel 714 to detach or disconnect the fixture 706 and the cover assembly 700. For example, the bayonet plate 716 includes a connection interface 718 that is configured to move through the non-uniform diameter and/or dimensions of the cover channel 714 to detach or disconnect the fixture 706 and the cover assembly 700.

The fixture 706 further includes a first support 720 that extends to an internal surface 722 of the cover lens 702 and a second support 724 that extends between the connection interface 718 and a wedge 726 that is configured to support a peripheral wall 728 of the cover housing 704 relative to the second support 724. Additionally, the wedge 726 may be configured to align with bayonet plate 716 relative to the first and/or second supports 720, 724 along either or both of the A-axis and O-axis. To support alignment, the wedge 726 includes a gasket 730 configured to separate surfaces of the wedge 726 from a second support internal extension 732 and a second support external extension 734 of the second support 724. The gasket 730 may be configured as an elastomeric material that has compressibility such that when wedge 726 is connected with the second support 724, the wedge contacts both the second support external extension 734 and a second support internal extension 732.

Between the lens 702 and the cover housing 704, an adhesive 736 may be configured to be uncured during assembly of the lens 702 and the cover housing 704, and once the lens 702 and/or the cover housing 704 are aligned along the A-axis and O-axis, the adhesive 736 may be cured through any means sufficient to cure the adhesive 736. The adhesives 736 may be cured by any means sufficient to form an irreversibly cured adhesive 736. For example, the adhesive 736 may be cured through pressure, gassing, moisture, ultraviolet light, heat, solvent evaporation, oxygen, or any combination thereof. The curing step of the adhesive may be performed before, during, or after an adjustment step of any lens (e.g., the lens 612 of FIGS. 6A-6C or the cover lens 702) relative to another component. The curing step may be carried out in one or two steps. For example, the curing step may be conducted by partially curing the adhesive 736, which may optionally induce shrinkage or partial shrinkage of the adhesive 736 and subsequently connecting the fixture 706 and the cover housing 704. The adhesive 736 may have viscosity sufficient to remain on any of the surfaces (i.e., the cover lens 702 or the cover housing 704) and not drip off before a connecting step with the fixture 706 or a curing step that cures the adhesive 736. The adhesive 736 may have a viscosity of between about 100 mPa-s, about 500 mPa-s, or about 1,000 mPa-s and about 2,000 mPa-s, about 5,000 mPa-s, or about 20,000 mPa-s. The adhesive 736 and the adhesive 634 of FIG. 6A-6C may be similar.

In some examples, the cover lens 702 may be connected with the adhesive 736 and/or the cover lens 702 at a lens shelf 738. When the fixture 706 is connected with the cover housing 704, the fixture 706 may align the lens 702 and the cover housing 704 along the A-axis and O-axis at the first and second supports 720, 724. Once aligned along the A-axis and O-axis, the adhesive 736 may be cured such that the cover assembly 700 is connectable with the lens assembly 600 of FIGS. 6A-6C.

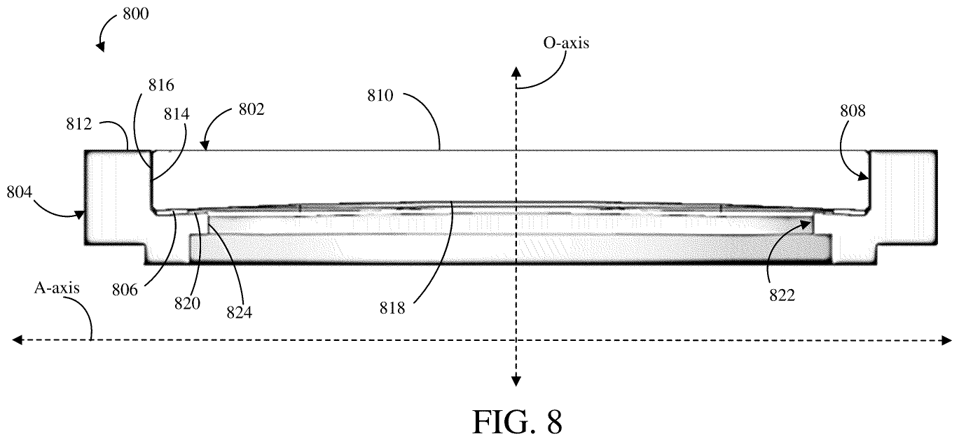

The internal surface 722 or an external surface 740 of the cover lens 702 may be planar or curved (either convex or concave, see e.g., cover lens 802 of FIG. 8) such that desirable focus and field of view is achieved when used with the lens assembly 600 of FIGS. 6A-6B. Accordingly, the first support 720 of the fixture 706 may be extended along the O-axis (or lens cavity) into or away from the cover lens 702 such that the cover lens 702 is supported relative to the lens shelf 738. The external surface 740 of the cover lens 702 may be aligned along the A-axis or be flush with a cover surface 742 of the cover housing 704 such that cover lens 702 is not tilted and, thus, unaligned with the O-axis. The cover surface 742 may define a periphery around the lens shelf 738 such that, when the cover lens 702 is connected with the adhesive 736, the internal surface 722 of the cover lens 702 is protected or separated from the external environment. Relative to the O-axis, the lens shelf 738 and the cover surface 742 may be separated by a distance sufficient to retain the cover lens 702 and have the cover lens 702 aligned with along the A-axis or flush with the cover surface 742. For example, the cover surface 742 and the lens shelf 738 may be separated by a distance of about 0.1 mm to about 10 mm, relative to the O-axis.

The first support 720 has a distal surface 744 that contacts the internal surface 722, and the distal surface 744 may have any configuration sufficient to support and align the cover lens 702 with the A-axis and/or O-axis. For example, the distal surface 744 may have a curved or flat surface configured to align with a curved or flat shape of the internal surface 722 of the cover lens 702. The distal surface 744 may be configured to push the cover lens 702 into a position such that the external surface 740 is flush with or aligned with, along the A-axis, the cover surface 742 of the cover lens 702. When the cover surface 742 and the external surface 740 are not aligned and the adhesive 736 is not fully cured, the cover lens 702 may be adjusted, such as by tilting the cover lens 702 relative to the A-axis, so that the cover surface 742 and the external surface 740 are flush and/or aligned along the A-axis.

The wedge 726 and the second support 724 may be configured to assist with aligning the external surface 740 of the cover lens 702 and the cover surface 742 of the cover housing 704. For example, the compressibility of the gasket 730 may adjust the position of the cover lens 702 into alignment with the A-axis before the adhesive 736 is cured. Because of the compressibility of the gasket 730 of the wedge 726, the gasket 730 may simulate connection with one or more housing bayonets, such as the bayonet 606 of FIGS. 6A-6C, such that there is high predictability that the cover lens 702 is aligned with the A-axis and the cover surface 742 during alignment with the fixture 706 and before connection with a lens assembly, such as the lens assembly 600 of FIGS. 6A-6C.

In some examples, the wedge 726 is temporarily used in combination with the cover assembly 700 and the fixture 706, and once the cover assembly 700 is assembled or manufactured, the fixture 706 is removed from the cover assembly 700 and then the wedge 726 is removed from the cover assembly 700. In other examples, the wedge 726 is affixed or connected with the cover assembly through an adhesive (not shown) or other fastener (not shown) and is used to assist connection with a lens assembly, such as the lens assembly 600 of FIGS. 6A-6C.

FIG. 8 is a cross-sectional view of a cover assembly 800. The cover assembly 800 includes a cover lens 802, which may be similar to the cover lens 702 of FIGS. 7A-7C, and a cover housing 804, which may be similar to the cover housing 704 of FIGS. 7A-7C. The cover lens 802 and the cover housing 804 are connected by an adhesive 806, which may be similar to the adhesive 736 of FIGS. 7A-7C, such that when cured, the cover lens 802 and the cover housing 804 are aligned along the A-axis and the O-axis.

The cover lens 802 is connected with the cover housing 804 at a cavity 808 (e.g., a lens cavity) that is configured to receive the cover lens 802 such that an external surface 810 of the cover lens 802 is flush with or aligned along the A-axis with a cover surface 812 of the cover housing 804. Alignment with the A-axis may mean that the cover surface 812 and the external surface 810 are both or separately parallel with the A-axis. In some examples, the external surface 810 is extended above or below the cover housing 804 along the O-axis while connected with the cover housing 804 within the cavity 808 that the cover lens 802 is protected by or pronounced from the cover housing 804.

Within the cavity 808, the cover housing 804 includes cavity peripheral surface 814 that are configured to receive the cover lens 802. Generally, the cavity peripheral surface 814 and lens peripheral surface 816 of the cover lens 802 are parallel with the O-axis such that the cover lens 802 can be received within the cavity 808. At an internal surface 818 of the cover lens 802, the cover lens 802 connects with the cover housing 804 at the adhesive 806 that is supported by a support flange 820. The support flange 820 extends from the cavity peripheral surface 814 at an angle such that the cover lens 802 is desirably aligned along the A-axis and/or O-axis. The angle of extension of the support flange 820 relative to the cavity peripheral surface 814 may be any desirable angle sufficient to support the adhesive 806 and avoid leaking or dripping of the adhesive 806 before the adhesive is cured. The angle may be sufficient to align with or mirror the curvature or geometry of the internal surface 818 of the cover lens 802. The angle may be sufficient to support the cover lens 802 through direct contact (e.g., at the internal surface 818) or indirect contact (e.g., through the adhesive 806). The angle may be between about 5 and 175 degrees.

The adhesive 806 may be configured to connect the internal surface 818 and the support flange 820 through direct contact or such that the components are free of contact. The amount of adhesive 806 before or after curing may be such that the adhesive 806 partially or fully covers the support flange 820. The adhesive 806 may contact any amount of the cover lens 802 that overlays or is adjacent to the lens peripheral surface 816 or the internal surface 818. The adhesive 806, when cured, may have any thickness sufficient to waterproof the cover lens 802 and the cover housing 804 while retaining advantageous optical properties. For example, the adhesive 806 may have a thickness of about 0.01 microns to about 10 microns.

Along the O-axis and within the cavity 808, an optical channel 822 is defined. The optical channel 822 is the area though which light may pass from the cover lens 802 to the imaging sensor (not shown). The optical channel 822 may have any diameter sufficient to receive light and assist in capturing of images. Generally, the diameter of the optical channel 822 is less than the distance between the cavity peripheral surface 814 because the cover lens 802 is supported by the support flange 820 and lateral surface 824 of the support flange 820 define the optical channel 822. For example, the diameter of the optical channel 822 may be between about 5 and 100 mm.

In this example, the internal surface 818 of the cover lens 802 is curved and the external surface 810 is flat. The imaging sensor (not shown) uses a designated square of the landscape to detect light through the cover lens 802. Curvature of the internal surface 818 allows for a larger circle through which light can pass, compared to a flat or planar internal surface (not show), such that a larger designated square can be utilized in light detection. With this configuration, light is facilitated between the lens peripheral surface 816 to the optical channel 822 because the internal surface 818 is curved and effectively has more surface area, which improves the optics of the camera's lens (e.g., the lens 612 of FIGS. 6A-6C) and subsequently the imaging sensor (not shown). Additionally, if the external surface 810 is curved (not shown), the optics of the image capture apparatus (not shown) are further improved because a larger circle and a larger designated square can be used for light detection. In either configuration of the external surface 810 and/or internal surface818 being curved, optics can be improved over only flat or planar surfaces or a smaller lens within the camera can be used to achieve the same optical properties of a larger flat lens (size differences in lenses not illustrated). The curvature of the internal surfaces 810 or the external surfaces 810 may be of any amount of curvature sufficient to achieve desirable optical properties. The curvature of the internal lens 802 may be chosen such that the internal lens 802 substantially aligns with the support flange 820.

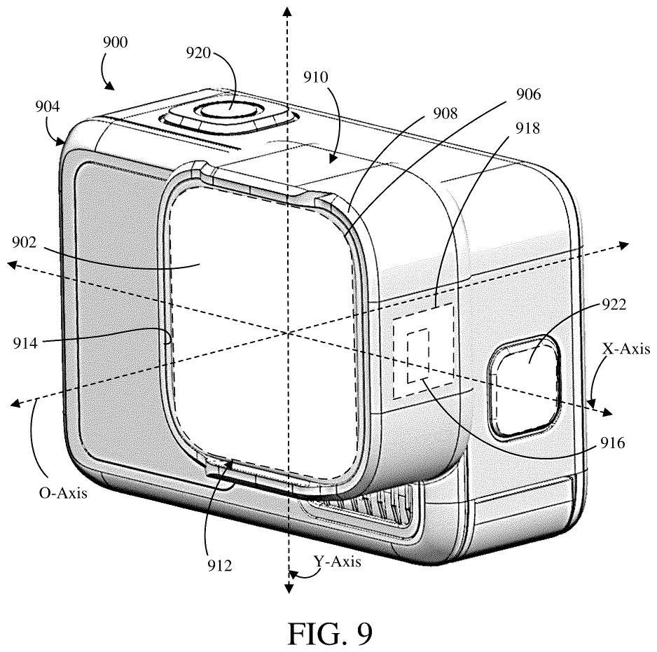

FIG. 9 is a perspective view of an image capture apparatus 900. The image capture apparatus 900 may be similar to the image capture apparatuses 100, 200, 300, 400 of FIGS. 1A-4B. The image capture apparatus 900 includes an internal lens 902 and a housing 904 that are connected at one or both of a lens mount 906 and/or an outer housing 908 of a housing lens assembly 910. A cover lens assembly 912 includes a cover lens 914 that overlays the internal lens 902 and a connection interface 916 that is configured to connect with a connection mechanism 918 of the lens mount 906. The connection mechanism 918 is positioned between the lens mount 906 and the outer housing 908 such that the cover lens assembly 912 is configured to overlay the internal lens 902 and extend between the lens mount 906 and the outer housing 908 until the connection interface 916 connect.

Because the cover lens assembly 912 connects with the housing lens assembly 910 between the lens mount 906 and the outer housing 908, the cover lens 914 is insulated or protected from external impacts, such as dropping or bumping, of the outer housing 908. The connection mechanism 918 and/or the connection interface 916 may be configured as any locking mechanism that is releasably connectable. The connection mechanism 918 and/or the connection interface 916 may be configured to work with multiple types of housing lens assembly 910 shapes, such as square (e.g., FIG. 9) or round (not shown). The connection mechanism 918 and/or the connection interface 916 may be configured to be locked and released by any user action, such as by actuating one of the buttons 920, 922. In some examples, the connection mechanism 918 and/or the connection interface 916 may be configured to lock and/or release the cover lens assembly 912 and the housing lens assembly 910, while simultaneously controlling alignment of the lens assembly 912 relative to the imaging sensor (not shown) along at least one of the X-axis, Y-axis, and/or O-axis. The connection mechanism 918 and/or the connection interface 916 may be configured as a pin and slot, a conical fit, a cylindrical fit, a press fit, a bias fit, or any combination thereof.

At the distal surface of the outer housing 908 (relative to the buttons 920, 922 or the housing 904), the outer housing 908 may be flush with or extend beyond the cover lens 914 such that the cover lens 914 has additional protection from external impacts. For example, if the image capture apparatus 900 was dropped and impacted at the distal surface of the outer housing 908, the distal surface may absorb a substantial amount of the impact such that the cover lens assembly 912 is not misaligned or damaged.

On an outside of the housing 904, buttons 920, 922 are included that are configured to control one or more operations of the image capture apparatus 900. For example, the buttons 920, 922 may separately or in combination control operations described, such as in relation to FIG. 5. In some examples, one or both of the buttons 920, 922 control whether the connection interface 916 and the connection mechanism 918 are connected or released from each other, such as in the case of a snap fit. For example, when the cover lens assembly 912 is connected with the housing lens assembly 910, operation of one or both of the buttons 920, 922 may control whether the cover lens assembly 912 is fixed to or released from the housing lens assembly 910.

In some examples, the connection interface 916 and the connection mechanism 918 may adjust the alignment of the cover lens 914 relative to the internal lens 902 such that the cover lens 914 and the internal lens 902 are desirably aligned along one or more of the O, X, and/or Y-axis. For example, one or more of the buttons 920, 922 may be used to adjust the position of the cover lens assembly 912. Proper position or alignment along one or more of the O, X, and/or Y-axis may be determined by user analysis of images or by identification through quality control software of the imaging sensor (not shown).

The methods and techniques of METHODS AND ASSEMBLIES TO CONNECT A LENS ASSEMBLY described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of METHODS AND ASSEMBLIES TO CONNECT A LENS ASSEMBLY described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, or an image capture device of the image capture apparatus 500 shown in FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lens assembly, comprising:
a lens barrel defining an optical axis, comprising:
a lens mounting surface orthogonal to the optical axis; and
a lateral alignment wall parallel with the optical axis;
a lens mount that surrounds at least a portion of and is connected with the lens barrel;
a connection flange extended from either the lens barrel and/or the lens mount;
a bayonet, comprising:
a base;
a locking mechanism having a lateral internal wall extended parallel from the base relative to the optical axis and a support wall extended orthogonal from the lateral internal wall relative to the optical axis; and
a support flange extended from the base and toward the connection flange such that the support flange and the connection flange are aligned; and
an adhesive that connects the support flange and the connection flange.

2. The lens assembly of claim 1, wherein the connection flange and the support flange are collaterally aligned.

3. The lens assembly of claim 1, wherein the lens barrel and the bayonet are aligned along the optical axis.

4. The lens assembly of claim 1, wherein the adhesive contacts surfaces of the support flange and the connection flange that are either orthogonal or parallel to the optical axis.

5. The lens assembly of claim 1, wherein the adhesive contacts surfaces of both the support flange and the connection flange that are orthogonal and parallel with the optical axis.

6. The lens assembly of claim 1, further comprising:
a fixture configured to axially align the bayonet and the lens barrel with the optical axis before curing of the adhesive.

7. The lens assembly of claim 6, wherein the fixture comprises,
a first support configured to contact the lens mounting surface and the lateral alignment wall of the lens barrel;
a second support configured to contact the lateral internal wall of the bayonet;
a channel defined between the first support and the second support; and
a peripheral wall extended around the second support and configured to contact the support wall.

8. A lens assembly, comprising:
a cover assembly, comprising:
a cover housing that defines:
a cover channel configured to interface with a housing bayonet; and
a lens cavity disposed between a peripheral wall and a lens shelf; and
a cover lens positioned within the lens cavity and free of contact with the lens shelf at an internal surface of the cover lens;
a bayonet plate connected with the cover assembly and configured to interface with the housing bayonet; and
an adhesive that connects the lens shelf and the cover lens.

9. The lens assembly of claim 8, wherein the cover lens comprises an external surface that is planar and parallel relative to the lens shelf, and wherein the lens shelf and the external surface are orthogonal relative to an optical axis.

10. The lens assembly of claim 9, wherein the cover lens comprises the internal surface and the external surface are planar and parallel relative to inner surface.

11. The lens assembly of claim 9, wherein the cover lens is aligned along the optical axis.

12. The lens assembly of claim 11, wherein the cover lens is free of contact with the peripheral wall.

13. The lens assembly of claim 9, further comprising:
a fixture, comprising:
a first support configured to align the cover lens and the lens shelf at the optical axis; and
a second support extended from a channel between the first support and the second support, the second support configured to connect with the bayonet plate at the cover channel.

14. The lens assembly of claim 13, wherein the first support is configured to extend through the lens cavity and above a plane of the lens shelf, and wherein the second support is configured as a bayonet connection.

15. An image capture apparatus, comprising:
a lens having:
an outer surface that is planar or convex;
an inner surface that is concave; and
a peripheral surface that connects the inner surface and the outer surface;
a housing that defines a cavity configured to align with the peripheral surface and has a support flange extended from the cavity at an angle sufficient to align with a portion of the inner surface of the lens; and
an adhesive that connects the support flange and the inner surface.

16. The image capture apparatus of claim 15, wherein the support flange and the inner surface have an angle that is substantially similar relative to the peripheral surface.

17. The image capture apparatus of claim 16, wherein the outer surface is convex.

18. The image capture apparatus of claim 17, wherein the peripheral surface and sides of the cavity are parallel relative to each other.

19. The image capture apparatus of claim 15, wherein outer surface is planar and substantially perpendicular relative to an optical axis that extends from an imaging sensor.

20. The image capture apparatus of claim 15, wherein the support flange and the inner surface have an angle that is different relative to the peripheral surface.
